(19) United States
(12) Patent Application Publication
(10) Pub. No.: US 2023/0413261 A1
(43) Pub. Date: Dec. 21, 2023

(54) Techniques for coexistence of multiple radio access technologies

(71) Applicant: Apple Inc., Cupertino, CA (US)

(72) Inventors: Jinjing Jiang, Campbell, CA (US); Qi Wang, Mountain View, CA (US); Yong Liu, Campbell, CA (US); Oren Shani, Saratoga, CA (US); Zhou Lan, San Jose, CA (US); Su Khiong Yong, Palo Alto, CA (US); Jarkko L Kneckt, Los Gatos, CA (US)

(21) Appl. No.: 18/333,666

(22) Filed: Jun. 13, 2023

Related U.S. Application Data
(60) Provisional application No. 63/352,939, filed on Jun. 16, 2022.

(51) Int. Cl. H04W 72/12; H04W 56/00; H04B 1/715

(52) U.S. Cl. CPC H04W 72/1215; H04W 56/0015; H04B 1/715; H04W 88/06

(57) ABSTRACT

Methods, systems and apparatuses for managing coexistence interference by an access point (AP) and wireless device are described. The wireless device may perform communication with the AP and with another device. The wireless device may indicate characteristics of its communication patterns with the other device to the AP. The AP may determine times to communicate and/or avoid communication with the wireless device based on the characteristics.

### PRIORITY INFORMATION

This application claims the benefit of priority to U.S. Provisional Application No. 63/352,939, entitled “Techniques for Coexistence of Multiple Radio Access Technologies”, filed Jun. 16, 2022, which is hereby incorporated by reference in its entirety as though fully and completely set forth herein.

### FIELD

The present application relates to wireless communications, including techniques for wireless communication using multiple radio access technologies.

### DESCRIPTION OF THE RELATED ART

Wireless communication systems are rapidly growing in usage. Further, wireless communication technology has evolved from voice-only communications to also include the transmission of data, such as Internet and multimedia content. A popular short/intermediate range wireless communication standard is wireless local area network (WLAN). Most modern WLANs are based on the IEEE 802.11 standard (and/or 802.11, for short) and are marketed under the Wi-Fi brand name. WLAN networks link one or more devices to a wireless access point, which in turn provides connectivity to the wider area Internet.

In 802.11 systems, devices that wirelessly connect to each other are referred to as “stations”, “mobile stations”, “user devices”, “user equipment”, or STA or UE for short. Wireless stations can be either wireless access points or wireless clients (and/or mobile stations). Access points (APs), which are also referred to as wireless routers, act as base stations for the wireless network. APs transmit and receive radio frequency signals for communication with wireless client devices. APs may also couple to the Internet in a wired and/or wireless fashion. Wireless clients operating on an 802.11 network can be any of various devices such as laptops, tablet devices, smart phones, smart watches, or fixed devices such as desktop computers. Wireless client devices are referred to herein as user equipment (and/or UE for short). Some wireless client devices are also collectively referred to herein as mobile devices or mobile stations (although, as noted above, wireless client devices overall may be stationary devices as well).

Mobile electronic devices may take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. In other words, there is an increasingly wide range of desired device complexities, capabilities, traffic patterns, and other characteristics.

Some devices may operate according to multiple radio access technologies (RATs). One RAT may interfere with another. Improvements in the field are desired.

### SUMMARY

Embodiments described herein relate to systems, methods, apparatuses, and mechanisms for coexistence of multiple RATs.

In some embodiments, a wireless device may establish communication with an access point (AP) according to a first radio access technology (RAT) and may establish communication with a second device according to a second RAT different from the first RAT. The wireless device may determine that the communication with the second device according to the second RAT is periodic communication. In response to the determination that the communication with the second device according to the second RAT is periodic communication, the wireless device may determine at least one of: the starting time of next periodic communication; or a periodicity of the periodic communication; or a periodic communication duration of the periodic communication, wherein the communication with the second device according to the second RAT occurs during respective communication durations of respective periods of the periodic communication. The wireless device may transmit, to the AP, an indication of the at least one of: the starting time of next periodic communication; or the periodicity of the periodic communication; or the periodic communication duration of the periodic communication.

In some embodiments, a wireless device may establish first communication with an access point (AP) according to a first radio access technology (RAT) and establish second communication with a second device according to a second RAT different from the first RAT. The wireless device may determine that the first communication and the second communication are scheduled according to a first coexistence scheme in which: the first communication and the second communication are scheduled according to time division multiplexing; the first communication occurs in fixed duration time windows; and the second communication occurs in variable duration time windows. In response to the determination that the first communication and the second device are scheduled according to the first coexistence scheme: determine, for a first fixed duration time window, an amount of time remaining in the first fixed duration time window; and transmit, to the AP, an indication of the amount of time remaining in the first fixed duration time window.

In some embodiments, a method, at an access point (AP) may comprise: establishing communication with a wireless device according to a first radio access technology (RAT). The method may include receiving, from the wireless device, a first indication that the wireless device is performing periodic communication with a second device according to a second RAT, wherein the first indication comprises at least one of: a periodicity of the periodic communication; or a periodic communication duration of the periodic communication, wherein the communication with the second device occurs during respective communication durations of respective periods of the periodic communication. In response to the first indication, the method may include determining to avoid scheduling communication with the wireless device during at least a first periodic communication duration.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system, according to some embodiments.

FIG. 2 illustrates an example simplified block diagram of a wireless device, according to some embodiments.

FIG. 3 illustrates an example WLAN communication system, according to some embodiments.

FIG. 4 illustrates an example simplified block diagram of a WLAN Access Point (AP), according to some embodiments.

FIG. 5 illustrates an example simplified block diagram of a wireless station (STA), according to some embodiments.

FIG. 6 illustrates an example simplified block diagram of a wireless node, according to some embodiments.

FIG. 7 illustrates an example method of communication, according to some embodiments.

FIGS. 8-11 illustrate example aspects of the method of FIG. 7, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present application. Definitions of the most prominently used acronyms that may appear throughout the present application are provided below:
UE: User Equipment
AP: Access Point
STA: Wireless Station
TX: Transmission/Transmit
RX: Reception/Receive
MLD: Multi-link Device
LAN: Local Area Network
WLAN: Wireless LAN
RAT: Radio Access Technology
QoS: Quality of Service
UL: Uplink
DL: Downlink

### Terminology

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (and/or combination of devices) having at least one processor that executes instructions from a memory medium.

Mobile Device (and/or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™, Samsung Galaxy™, etc. Various other device types would fall into this category if they include Wi-Fi or both cellular and Wi-Fi communication capabilities, such as laptop computers (e.g., MacBook™), portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (and/or combination of devices) which is easily transported by a user and capable of wireless communication using WLAN or Wi-Fi.

Wireless Device (and/or Wireless Station)—any of various types of computer systems devices which performs wireless communications using WLAN communications. As used herein, the term “wireless device” may refer to a mobile device, as defined above, or to a stationary device, such as a stationary wireless client or a wireless base station. For example, a wireless device may be any type of wireless station of an 802.11 system, such as an access point (AP) or a client station (STA or UE). Further examples include televisions, media players (e.g., AppleTV™, Roku™, Amazon FireTV™, Google Chromecast™, etc.), refrigerators, laundry machines, thermostats, and so forth.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Processing Element—refers to various implementations of digital circuitry that perform a function in a computer system. Additionally, processing element may refer to various implementations of analog or mixed-signal (combination of analog and digital) circuitry that perform a function (and/or functions) in a computer or computer system.

Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, e.g., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, signaling, messaging, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

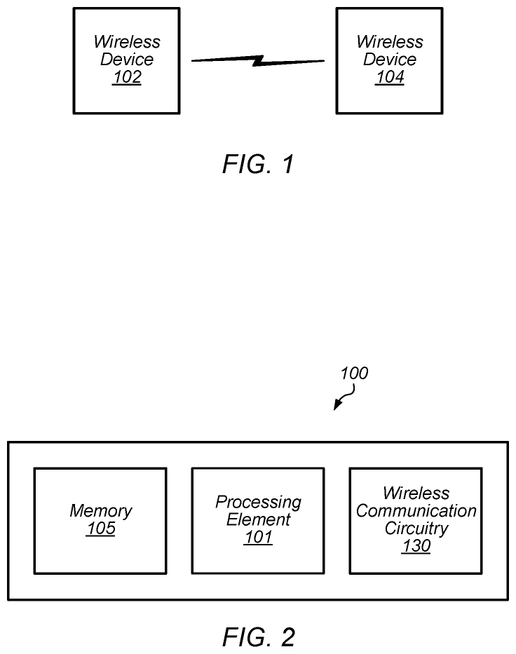

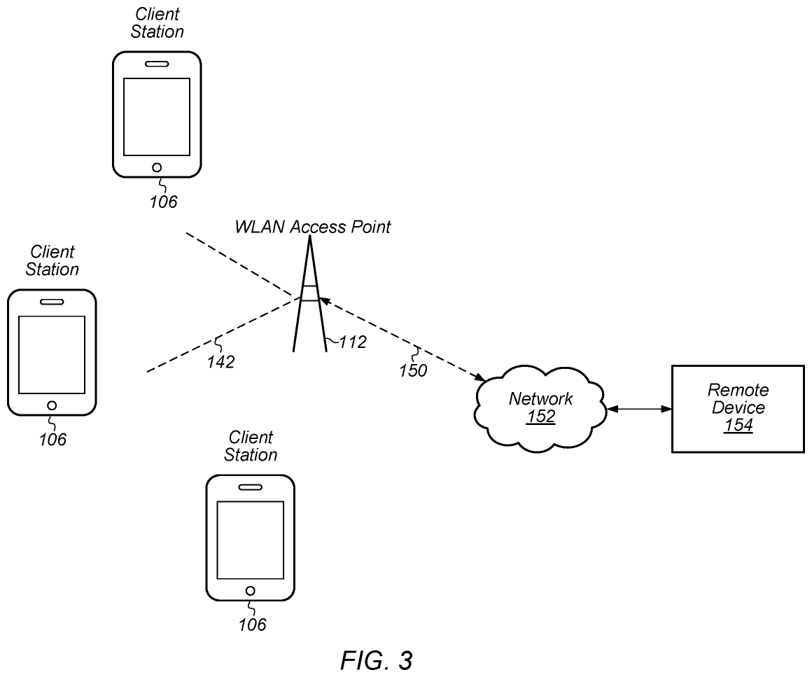

### FIGS. 1-2—Wireless Communication System

FIG. 1 illustrates an exemplary (and simplified) wireless communication system in which aspects of this disclosure may be implemented. It is noted that the system of FIG. 1 is merely one example of a possible system, and embodiments of this disclosure may be implemented in any of various systems, as desired.

As shown, the exemplary wireless communication system includes a (“first”) wireless device 102 in communication with another (“second”) wireless device. The first wireless device 102 and the second wireless device 104 may communicate wirelessly using any of a variety of wireless communication techniques.

As one possibility, the first wireless device 102 and the second wireless device 104 may perform communication using wireless local area networking (WLAN) communication technology (e.g., IEEE 802.11/Wi-Fi based communication) and/or techniques based on WLAN wireless communication. One or both of the wireless device 102 and the wireless device 104 may also be capable of communicating via one or more additional wireless communication protocols, such as any of Bluetooth (BT), Bluetooth Low Energy (BLE), near field communication (NFC), GSM, UMTS (WCDMA, TDSCDMA), LTE, LTE-Advanced (LTE-A), NR, 3GPP2 CDMA2000 (e.g., 1×RTT, 1×EV-DO, HRPD, eHRPD), Wi-MAX, GPS, etc.

The wireless devices 102 and 104 may be any of a variety of types of wireless device. As one possibility, one or more of the wireless devices 102 and/or 104 may be a substantially portable wireless user equipment (UE) device, such as a smart phone, hand-held device, a wearable device such as a smart watch, a tablet, a motor vehicle, or virtually any type of wireless device. As another possibility, one or more of the wireless devices 102 and/or 104 may be a substantially stationary device, such as a set top box, media player (e.g., an audio or audiovisual device), gaming console, desktop computer, appliance, door, access point, base station, or any of a variety of other device types.

Each of the wireless devices 102 and 104 may include wireless communication circuitry configured to facilitate the performance of wireless communication, which may include various digital and/or analog radio frequency (RF) components, a processor that is configured to execute program instructions stored in memory, a programmable hardware element such as a field-programmable gate array (FPGA), and/or any of various other components. The wireless device 102 and/or the wireless device 104 may perform any of the method embodiments described herein, or any portion of any of the method embodiments described herein, using any or all of such components.

Each of the wireless devices 102 and 104 may include one or more antennas for communicating using one or more wireless communication protocols. In some cases, one or more parts of a receive and/or transmit chain may be shared between multiple wireless communication standards; for example, a device might be configured to communicate using either of Bluetooth or Wi-Fi using partially or entirely shared wireless communication circuitry (e.g., using a shared radio or at least shared radio components). The shared communication circuitry may include a single antenna, or may include multiple antennas (e.g., for MIMO) for performing wireless communications. Alternatively, a device may include separate transmit and/or receive chains (e.g., including separate antennas and other radio components) for each wireless communication protocol with which it is configured to communicate. As a further possibility, a device may include one or more radios or radio components which are shared between multiple wireless communication protocols, and one or more radios or radio components which are used exclusively by a single wireless communication protocol. For example, a device might include a shared radio for communicating using one or more of LTE, CDMA2000 1×RTT, GSM, and/or 5G NR, and separate radios for communicating using each of Wi-Fi and Bluetooth. Other configurations are also possible.

As previously noted, aspects of this disclosure may be implemented in conjunction with the wireless communication system of FIG. 1. For example, a wireless device (e.g., either of wireless devices 102 or 104) may be configured to perform methods of communication to improve performance in view of in-device coexistence interference between multiple RATs..

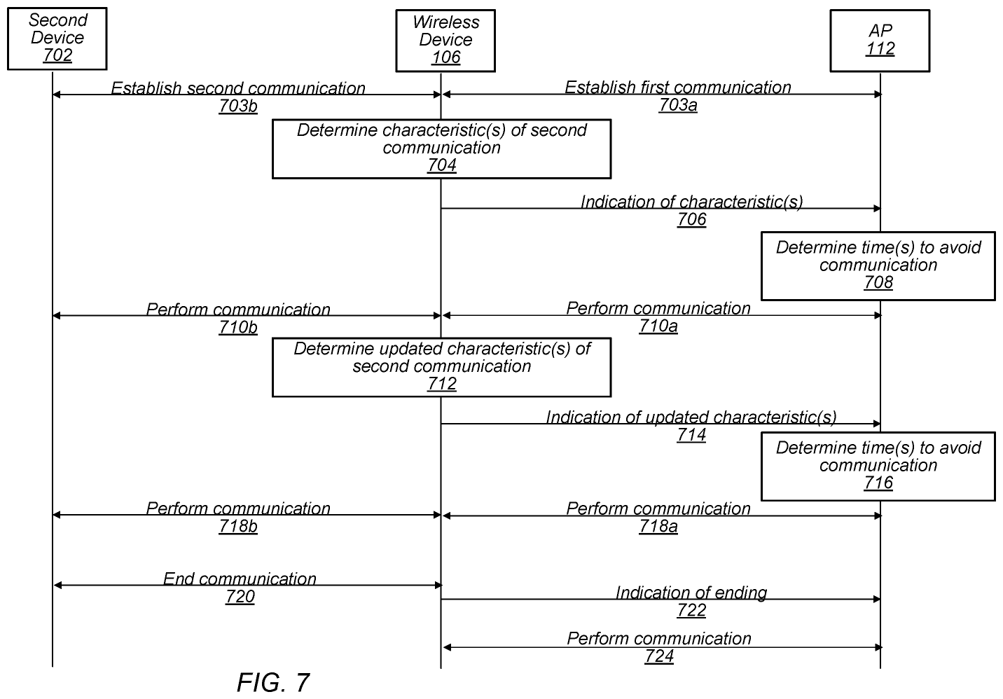

FIG. 6 illustrates an exemplary wireless device 100 (e.g., corresponding to wireless devices 102 and/or 104) that may be configured for use in conjunction with various aspects of the present disclosure. The device 100 may be any of a variety of device types and may be configured to perform any of a variety of types of functionality. The device 100 may be a substantially portable device or may be a substantially stationary device, potentially including any of a variety of device types. The device 100 may be configured to perform one or more wireless communication techniques or features, such as any of the techniques or features illustrated and/or described subsequently herein with respect to any or all of the Figures.

As shown, the device 100 may include a processing element 101. The processing element may include or be coupled to one or more memory elements. For example, the device 100 may include one or more memory media (e.g., memory 105), which may include any of a variety of types of memory and may serve any of a variety of functions. For example, memory 105 could be RAM serving as a system memory for processing element 101. Other types and functions are also possible.

Additionally, the device 100 may include wireless communication circuitry 130. The wireless communication circuitry may include any of a variety of communication elements (e.g., antenna(s) for wireless communication, analog and/or digital communication circuitry/controllers, etc.) and may enable the device to wirelessly communicate using one or more wireless communication protocols.

Note that in some cases, the wireless communication circuitry 130 may include its own processing element (e.g., a baseband processor), e.g., in addition to the processing element 101. For example, the processing element 101 may be an ‘application processor’ whose primary function may be to support application layer operations in the device 100, while the wireless communication circuitry 130 may be a ‘baseband processor’ whose primary function may be to support baseband layer operations (e.g., to facilitate wireless communication between the device 100 and other devices) in the device 100. In other words, in some cases the device 100 may include multiple processing elements (e.g., may be a multi-processor device). Other configurations (e.g., instead of or in addition to an application processor/baseband processor configuration) utilizing a multi-processor architecture are also possible.

The device 100 may additionally include any of a variety of other components (not shown) for implementing device functionality, depending on the intended functionality of the device 100, which may include further processing and/or memory elements (e.g., audio processing circuitry), one or more power supply elements (which may rely on battery power and/or an external power source) user interface elements (e.g., display, speaker, microphone, camera, keyboard, mouse, touchscreen, etc.), and/or any of various other components.

The components of the device 100, such as processing element 101, memory 105, and wireless communication circuitry 130, may be operatively coupled via one or more interconnection interfaces, which may include any of a variety of interface types, possibly including a combination of multiple interface types. As one example, a USB high-speed inter-chip (HSIC) interface may be provided for inter-chip communications between processing elements. Alternatively (and/or in addition), a universal asynchronous receiver transmitter (UART) interface, a serial peripheral interface (SPI), inter-integrated circuit (I2C), system management bus (SMBus), and/or any of a variety of other communication interfaces may be used for communications between various device components. Other interface types (e.g., intra-chip interfaces for communication within processing element 101, peripheral interfaces for communication with peripheral components within or external to device 100, etc.) may also be provided as part of device 100.

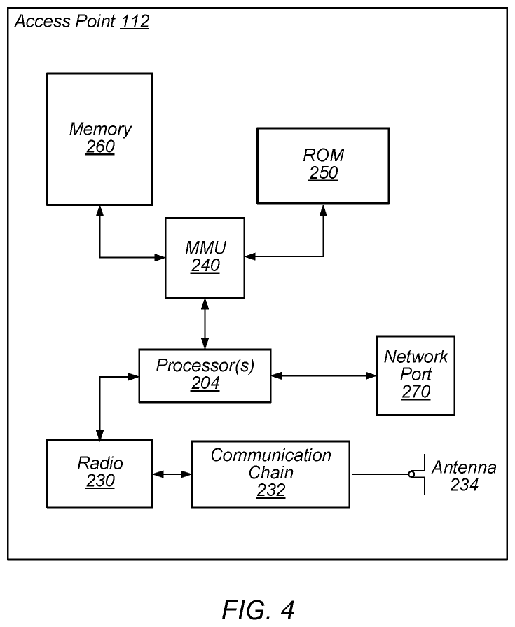

### FIG. 3—WLAN System

FIG. 3 illustrates an example WLAN system according to some embodiments. As shown, the exemplary WLAN system includes a plurality of wireless client stations or devices (e.g., STAs or user equipment (UEs)), 106 that are configured to communicate over a wireless communication channel 142 with an Access Point (AP) 112. The AP 112 may be a Wi-Fi access point. The AP 112 may communicate via a wired and/or a wireless communication channel 150 with one or more other electronic devices (not shown) and/or another network 152, such as the Internet. Additional electronic devices, such as the remote device 154, may communicate with components of the WLAN system via the network 152. For example, the remote device 154 may be another wireless client station, a server associated with an application executing on one of the STAs 106, etc. The WLAN system may be configured to operate according to any of various communications standards, such as the various IEEE 802.11 standards. In some embodiments, at least one wireless device 106 is configured to communicate directly with one or more neighboring mobile devices, without use of the access point 112.

Further, in some embodiments, a wireless device 106 (which may be an exemplary implementation of device 100) may be configured to perform methods for communication in a manner to reduce/avoid coexistence while communicating according to multiple RATs.

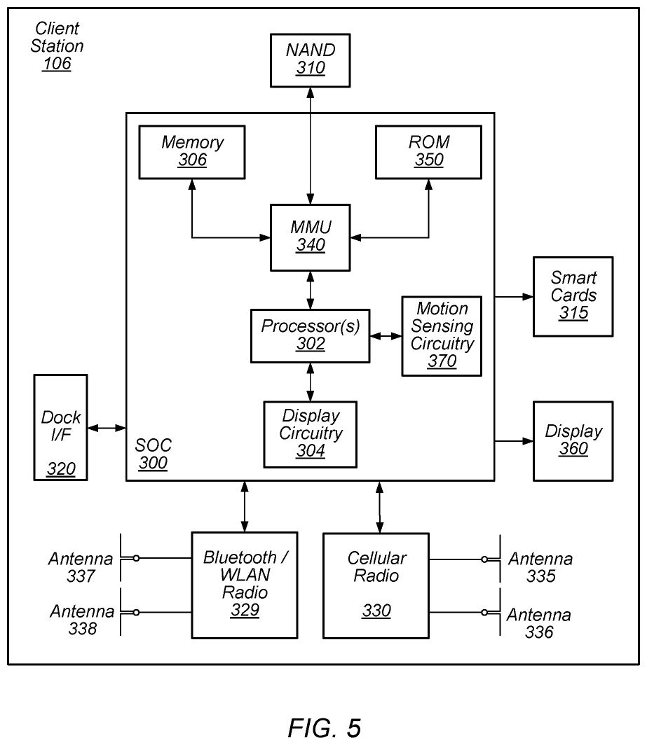

### FIG. 4—Access Point Block Diagram

FIG. 4 illustrates an exemplary block diagram of an access point (AP) 112, which may be one possible exemplary implementation of the device 100 illustrated in FIG. 4. It is noted that the block diagram of the AP of FIG. 4 is only one example of a possible system. As shown, the AP 112 may include processor(s) 204 which may execute program instructions for the AP 112. The processor(s) 204 may also be coupled (directly or indirectly) to memory management unit (MMU) 240, which may be configured to receive addresses from the processor(s) 204 and to translate those addresses to locations in memory (e.g., memory 260 and read only memory (ROM) 250) or to other circuits or devices.

The AP 112 may include at least one network port 270. The network port 270 may be configured to couple to a wired network and provide a plurality of devices, such as mobile devices 106, access to the Internet. For example, the network port 270 (and/or an additional network port) may be configured to couple to a local network, such as a home network or an enterprise network. For example, port 270 may be an Ethernet port. The local network may provide connectivity to additional networks, such as the Internet.

The AP 112 may include at least one antenna 234, which may be configured to operate as a wireless transceiver and may be further configured to communicate with mobile device 106 via wireless communication circuitry 230. The antenna 234 communicates with the wireless communication circuitry 230 via communication chain 232. Communication chain 232 may include one or more receive chains, one or more transmit chains or both. The wireless communication circuitry 230 may be configured to communicate via Wi-Fi or WLAN, e.g., 802.11. The wireless communication circuitry 230 may also, or alternatively, be configured to communicate via various other wireless communication technologies, including, but not limited to, cellular (e.g., 5G, 4G, etc.), Bluetooth, etc., for example when the AP is co-located with a base station, such as in the case of a small cell, or in other instances when it may be desirable for the AP 112 to communicate via various different wireless communication technologies.

Further, in some embodiments, as further described below, AP 112 may be configured to perform methods for communication with a wireless device (e.g., 106) in a manner to reduce/avoid coexistence interference (e.g., at the wireless device) associated with a different RAT.

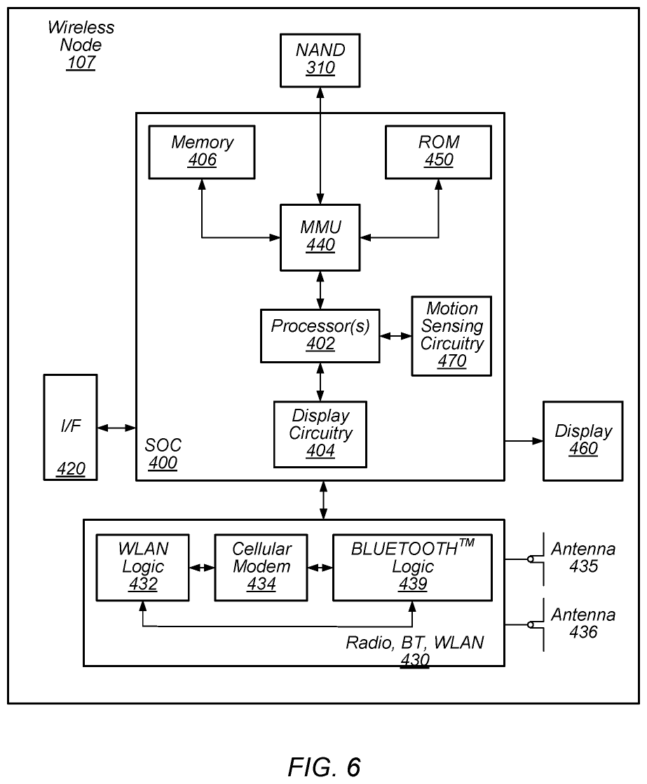

### FIG. 5—Client Station Block Diagram

FIG. 5 illustrates an example simplified block diagram of a client station 106, which may be one possible exemplary implementation of the device 100 illustrated in FIG. 4. According to embodiments, client station 106 may be a user equipment (UE) device, a mobile device or mobile station, and/or a wireless device or wireless station. As shown, the client station 106 may include a system on chip (SOC) 300, which may include portions for various purposes. The SOC 300 may be coupled to various other circuits of the client station 106. For example, the client station 106 may include various types of memory (e.g., including NAND flash 310), a connector interface (I/F) (and/or dock) 320 (e.g., for coupling to a computer system, dock, charging station, etc.), the display 360, cellular communication circuitry (e.g., cellular radio) 330 such as for cellular (e.g., 5G NR, 4G, etc.,) and/or short to medium range wireless communication circuitry (e.g., Bluetooth™/WLAN radio) 329 (e.g., Bluetooth™ and WLAN circuitry). The client station 106 may further include one or more smart cards 315 that incorporate SIM (Subscriber Identity Module) functionality, such as one or more UICC(s) (Universal Integrated Circuit Card(s)). The cellular communication circuitry 330 may couple to one or more antennas, such as antennas 335 and 336 as shown. The short to medium range wireless communication circuitry 329 may also couple to one or more antennas, such as antennas 337 and 338 as shown. Alternatively, the short to medium range wireless communication circuitry 329 may couple to the antennas 335 and 336 in addition to, or instead of, coupling to the antennas 337 and 338. The short to medium range wireless communication circuitry 329 may include multiple receive chains and/or multiple transmit chains for receiving and/or transmitting multiple spatial streams, such as in a multiple-input multiple output (MIMO) configuration. Some or all components of the short to medium range wireless communication circuitry 329 and/or the cellular communication circuitry 330 may be used for wireless communications, e.g., using WLAN, Bluetooth, and/or cellular communications.

As shown, the SOC 300 may include processor(s) 302, which may execute program instructions for the client station 106 and display circuitry 304, which may perform graphics processing and provide display signals to the display 360. The SOC 300 may also include motion sensing circuitry 370 which may detect motion of the client station 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 may be configured to perform memory protection and page table translation or set up. In some embodiments, the MMU 340 may be included as a portion of the processor(s) 302.

As noted above, the client station 106 may be configured to communicate wirelessly directly with one or more neighboring client stations. The client station 106 may be configured to communicate according to a WLAN RAT for communication in a WLAN network, such as that shown in FIG. 3 or in FIG. 1.

As described herein, the client station 106 may include hardware and software components for implementing the features described herein. For example, the processor 302 of the client station 106 may be configured to implement part or all of the features described herein, e.g., by executing program instructions stored on a memory medium (e.g., a non-transitory computer-readable memory medium). Alternatively (and/or in addition), processor 302 may be configured as a programmable hardware element, such as an FPGA (Field Programmable Gate Array), or as an ASIC (Application Specific Integrated Circuit). Alternatively (and/or in addition) the processor 302 of the UE 106, in conjunction with one or more of the other components 300, 304, 306, 310, 315, 320,329, 330, 335, 336, 337, 338, 340, 350, 360, 370 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 204.

Further, as described herein, cellular communication circuitry 330 and short-range wireless communication circuitry 329 may each include one or more processing elements. In other words, one or more processing elements may be included in cellular communication circuitry 330 and also in short range wireless communication circuitry 329. Thus, each of cellular communication circuitry 330 and short-range wireless communication circuitry 329 may include one or more integrated circuits (ICs) that are configured to perform the functions of cellular communication circuitry 330 and short-range wireless communication circuitry 329, respectively. In addition, each integrated circuit may include circuitry (e.g., first circuitry, second circuitry, etc.) configured to perform the functions of cellular communication circuitry 330 and short-range wireless communication circuitry 329.

### FIG. 6—Wireless Node Block Diagram

FIG. 6 illustrates one possible block diagram of a wireless node 107, which may be one possible exemplary implementation of the device 106 illustrated in FIG. 5. As shown, the wireless node 107 may include a system on chip (SOC) 400, which may include portions for various purposes. For example, as shown, the SOC 400 may include processor(s) 402 which may execute program instructions for the wireless node 107, and display circuitry 404 which may perform graphics processing and provide display signals to the display 460. The SOC 400 may also include motion sensing circuitry 470 which may detect motion of the wireless node 107, for example using a gyroscope, accelerometer, and/or any of various other motion sensing components. The processor(s) 402 may also be coupled to memory management unit (MMU) 440, which may be configured to receive addresses from the processor(s) 402 and translate those addresses to locations in memory (e.g., memory 406, read only memory (ROM) 450, flash memory 410). The MMU 440 may be configured to perform memory protection and page table translation or set up. In some embodiments, the MMU 440 may be included as a portion of the processor(s) 402.

As shown, the SOC 400 may be coupled to various other circuits of the wireless node 107. For example, the wireless node 107 may include various types of memory (e.g., including NAND flash 410), a connector interface 420 (e.g., for coupling to a computer system, dock, charging station, etc.), the display 460, and wireless communication circuitry 430 (e.g., for 5G NR, LTE, LTE-A, CDMA2000, Bluetooth, Wi-Fi, NFC, GPS, etc.).

The wireless node 107 may include at least one antenna, and in some embodiments, multiple antennas 435 and 436, for performing wireless communication with base stations and/or other devices. For example, the wireless node 107 may use antennas 435 and 436 to perform the wireless communication. As noted above, the wireless node 107 may in some embodiments be configured to communicate wirelessly using a plurality of wireless communication standards or radio access technologies (RATs).

The wireless communication circuitry 430 may include Wi-Fi Logic 432, a Cellular Modem 434, and Bluetooth Logic 439. The Wi-Fi Logic 432 is for enabling the wireless node 107 to perform Wi-Fi communications, e.g., on an 802.11 network. The Bluetooth Logic 439 is for enabling the wireless node 107 to perform Bluetooth communications. The cellular modem 434 may be capable of performing cellular communication according to one or more cellular communication technologies. Some or all components of the wireless communication circuitry 430 may be used for wireless communications, e.g., using WLAN, Bluetooth, and/or cellular communications.

As described herein, wireless node 107 may include hardware and software components for implementing embodiments of this disclosure. For example, one or more components of the wireless communication circuitry 430 (e.g., Wi-Fi Logic 432) of the wireless node 107 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

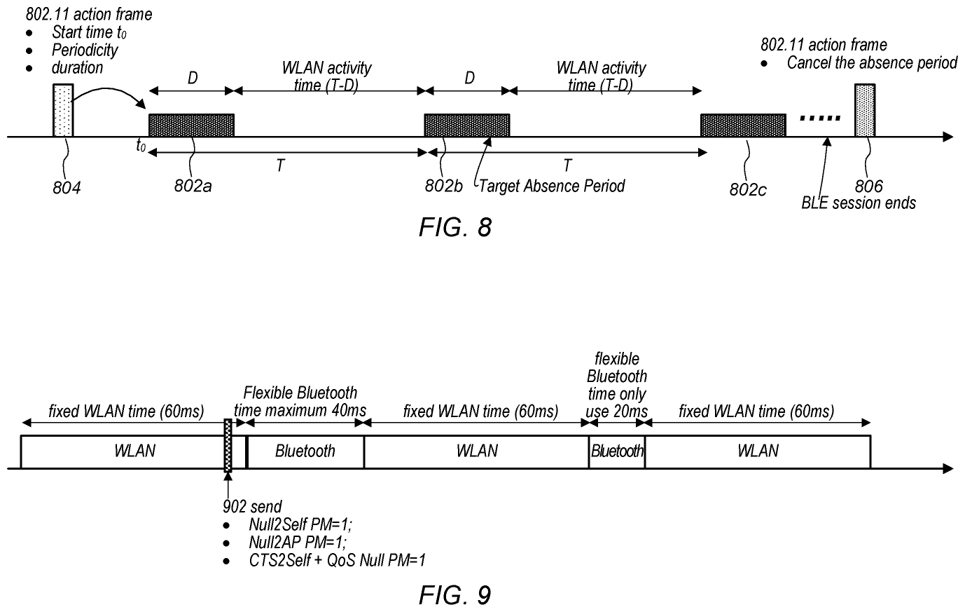

### FIG. 7—Communication Avoiding/Reducing Coexistence Interference

Different RATs may operate according to various time division multiplexing patterns, e.g., due to hardware limitations at a wireless device. In some cases, performance of one RAT (e.g., WLAN) may be significantly impacted during a time period when another RAT (e.g., Bluetooth (BT), Bluetooth Low Energy (BLE), cellular, etc.) is active at a wireless device. For example, during a coexistence (co-ex) event when a co-located radio (e.g., BT, BLE, cellular) may have higher priority than WLAN, an AP associated with the WLAN may not be aware that a wireless device cannot receive WLAN traffic. Thus, the wireless device may not receive WLAN traffic during such an event.

In some embodiments, a wireless device may send a power management (PM) frame to the AP indicating that the wireless device is entering a doze state, e.g., by indicating PM=1. However, in some circumstances, transmitting such a frame may not be reliable. For example, the wireless device may not be able to access the medium to transmit such a frame in a timely manner, e.g., because the AP or another device may be occupying the medium.

In some embodiments, traffic using such a co-located radio may have some repetitive and/or periodic characteristics. For example, some BLE traffic may be periodic. Similarly, some narrowband radio traffic (e.g., to assist an ultra-wideband radio) may be periodic. Thus, such BLE or narrowband radio traffic may occur periodically, and may result in periodic times when the wireless device may not receive WLAN traffic.

As another possible example of repetitive characteristics, a TDM mechanism may include fixed periods of time for one RAT in alternation with variable periods of time for a second RAT. For example, according to a BT profile, e.g., advanced audio distribution profile (A2DP), in coexistence with WLAN, a device may use a non-periodic TDM mechanism similar to: a fixed WLAN time, e.g., 60 ms (e.g., designed to support WLAN throughput performance) alternating with a flexible BT time (e.g., up to 40 ms, according to some embodiments). If the BT communication finishes prior to the end of the flexible time period, WLAN time can start right away.

Embodiments described herein provide systems, methods, and which may be used to reduce or avoid performance degradation associated with coexistence events. For example, a wireless device may inform the AP of characteristics of communication on a different RAT and the AP may use this information to avoid transmitting to the wireless device while the wireless device is unavailable to receive (e.g., due to prioritization of another radio). As one possibility, a wireless device may inform an AP of a target absence period and the AP may avoid sending downlink (DL) traffic to the wireless device during such periods.

Aspects of the method of FIG. 7 may be implemented by an AP in communication with a wireless device. The wireless device may also be in communication with a second device. The AP, wireless device, and/or second may be as illustrated in and described with respect to various ones of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. For example, one or more processors (or processing elements) (e.g., processor(s) 101, 204, 302, 402, 432, 434, 439, baseband processor(s), processor(s) associated with communication circuitry such as 130, 230, 232, 329, 330, 430, etc., among various possibilities) may cause a wireless device, STA, UE, and/or AP, or other device to perform such method elements.

Note that while at least some elements of the method of FIG. 7 are described in a manner relating to the use of communication techniques and/or features associated with IEEE and/or 802.11 (e.g., 802.11be, 802.11bX, Wi-Fi 8, etc.) specification documents, such description is not intended to be limiting to the disclosure, and aspects of the method of FIG. 7 may be used in any suitable wireless communication system, as desired.

The methods shown may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

A wireless device 106 may establish first communication with an AP 112 (703a) and second communication with a second device 702 (703b), according to some embodiments. The second device may be any type of device, e.g., such as a BT accessory, a second wireless device (e.g., 106/107), a cellular base station, or any other type of device configured to perform wireless communication, etc.

The first communication may be according to a first RAT. For example, the first RAT may be a WLAN RAT. The second communication may be according to a second RAT. The second RAT may be different than the first RAT. For example, the second RAT may be BT, BLE, cellular, narrowband, etc.

It will be appreciated that, although 703a and 703b are shown simultaneously, they may occur at different times and in any order.

The wireless device may determine one or more characteristics of the second communication (704), according to some embodiments. In some embodiments, the wireless device may make this determination in response to a determination that the first and second communication are overlapping (e.g., according to TDM) and/or that the second communication may cause coexistence interference for the first communication.

The characteristic(s) may relate to a communication pattern of the second communication. For example, the characteristic(s) may be related to a periodic and/or repetitive nature of the second communication.

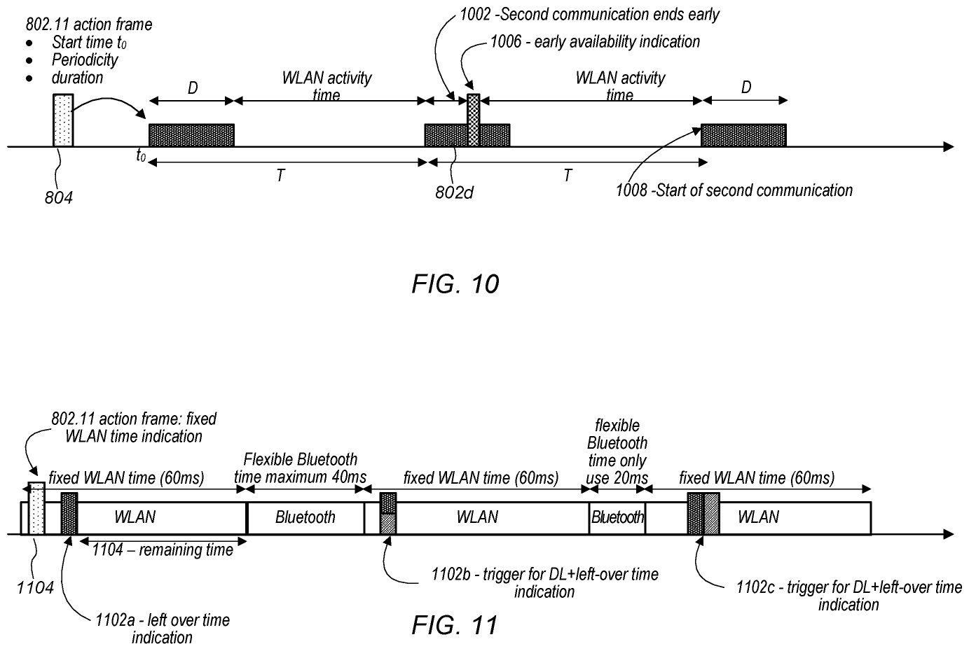

For example, if the second communication is periodic, the characteristics may include a period (T), duration (D), and/or start time (t₀) of the second communication, e.g., as illustrated in FIG. 8, according to some embodiments. A start time (t₀) may refer to the start of the period (T) and/or the communication duration (D). Note that in the example of FIG. 8, the period (T) and the communication duration (D) are aligned in that both start at the same time (e.g., start time (t₀)), however embodiments are not limited to this alignment.

Consider BLE (second communication) and WLAN (first communication) as an example. BLE connection events (802a, 802b, 802c) may be T=15 ms apart. In each connection event, up to 7 BLE packets per connection interval may be transmitted, and each BLE packet may take approximately 708 us to transmit. Thus, the duration of BLE activity may be D=˜5 ms. This may result in a WLAN activity time of approximately 10 ms per period. The WLAN activity time may be free of BLE co-ex requirements, according to some embodiments.

As another example, if the second communication is repetitive (e.g., but not periodic, e.g., due to a flexible duration), the characteristics may include a fixed amount of time for the first communication/RAT (e.g., WLAN) and/or a maximum amount of time for the second communication/RAT (e.g., BT). FIG. 9 illustrates an example of such repetitive communication, according to some embodiments. As noted above, the fixed duration may be 60 ms and the maximum amount of time may be 40 ms, but other durations and maximums may be used as desired.

In some embodiments, as shown in FIG. 9, a wireless device may use a message 902 (e.g., a power management (PM) frame) to indicate to the AP that the fixed duration is ending. Such a PM frame may be or include a Null2Self, Null2AP, and/or CTS2Self with a quality of service (QoS) indication of null, among various possibilities. Any of these PM frames may include an indication that PM=1. In response to receiving an indication that PM=1, an AP may set a PM bit to 1 and may therefore stop transmitting to the wireless device (e.g., for as long as PM=1.

In some embodiments, one or more bandwidth characteristic(s) of the second communication may be determined. For example, a co-located narrow band radio may use a smaller bandwidth compared with a typical WLAN transmission. Thus, if good in-device isolation is available, the wireless device may determine (and inform the AP) that particular frequency ranges (e.g., resource units (RU)) that should be avoided during times that the second communication is active. Thus, it may be possible that co-ex interference may be avoided without the AP totally avoiding DL transmission during times that the wireless device is engaged in the second communication. Thus, the wireless device may determine bandwidth characteristic(s) such as a (e.g., starting) center frequency f₀, a frequency hopping pattern (e.g., if used for the second communication), and/or a bandwidth (W).

In some embodiments, the characteristic(s) determined in 704 may be considered initial or baseline characteristic(s) (e.g., which may be updated when/if needed).

The wireless device may transmit, to the AP, an indication of the characteristic(s) (706), according to some embodiments. The indication may be transmitted in one or more frames, e.g., containing one or more field(s) for indicating the characteristic(s). For example, an action frame may include the indication. However, other types of frames/fields may be used as desired, e.g., such as an A-control header and/or block acknowledgement frame. The AP may receive the indication.

In some embodiments, all characteristics determined in 704 may be indicated. In some embodiments, only a subset of characteristics determined in 704 may be indicated. For example, for repetitive communication, a fixed duration may be indicated (e.g., 1104 in the example of FIG. 11). For example, when BT traffic starts and a co-existence scheme is in place, the wireless device may send an action frame to the AP indicating the fixed WLAN time. However, it will be appreciated that a maximum duration (e.g., of the second communication) may also be indicated. The wireless device may send updates when/if scheduling changes for the co-existence scheme. For periodic communication, a start time (t₀), period (T), and/or duration (D) may be indicated (e.g., 804 in the example of FIG. 8). Such an indication (1104 and/or 804) may be transmitted in an action frame.

In some embodiments, the determination (704) and indication (706) of the initial characteristics may be performed in response to the initiation of the second communication or to the initiation of the first communication.

The AP may determine one or more time(s) to avoid scheduling communication (e.g., transmitting DL frames) to the wireless device (708), according to some embodiments. For example, the AP may determine some time period(s) during which the wireless device may be available to receive DL communication and other time period(s) during which the wireless device may not be available to receive DL communications. Thus, the AP may transmit DL communications (e.g., only) when the wireless device is available to receive and may avoid DL transmissions at other times.

In the case of periodic communication, the indication may be considered as an indication of target absence period(s), e.g., when the wireless device may not be available. Thus, the AP may determine to avoid these times. For example, based on the start time (t₀), period (T), and/or duration (D), the AP may determine that the wireless device is likely to be unavailable during the duration of each period, and may thus schedule communication to the wireless device for other times (e.g., during the times given by T-D). For example, as shown in FIG. 8, the wireless device may transmit an action frame 804 (e.g., during 706) indicating the characteristics. The AP may determine a WLAN activity time (T-D) and target absence period (D) for each period (T). The target absence period may correspond to the communication duration of the second RAT (D) for each period.

In the case of repetitive communication, the indication may be considered as an indication of an available time. However, due to the variable duration of the second communication, the AP may not determine particular availability/avoidance times based on the initial characteristic(s) alone. For example, in the case of repetitive communication, 706 and 714 may be combined, e.g., for a determination of time(s) as discussed in 716, below.

In the case that bandwidth characteristics are indicated (e.g., or otherwise are known to the AP), the AP may further determine particular bandwidths to avoid and/or other bandwidths that may be used (e.g., even at times the wireless device is engaged in second communication).

The wireless device may perform first communication with the AP (710a) and second communication with the second device (710b), according to some embodiments.

The wireless device may alternate between the first/second communication, e.g., according to TDM. The AP may avoid transmitting DL communication to the wireless device at any time that the wireless device may be unavailable (e.g., as determined in 708).

In some embodiments, if bandwidth characteristics are used, the second communication may be frequency division multiplexed (FDM) with the first communication, e.g., at times that the second communication is active.

The wireless device may determine one or more updated characteristic(s) of the second communication (712), according to some embodiments.

In the case of periodic communication, the updated characteristic(s) may be or include: an updated start time (t₀) and/or an early availability, among various possibilities.

From time to time, an updated start time (t₀) may be determined, e.g., due to relative drift between the clocks of the first and second communication. For example, over time an overlap of WLAN activity time and a period that the wireless device is not available for WLAN reception (e.g., as determined in 708) may develop. Updating the start time may mitigate this problem. As an example, assume the relative clock drift is ±100 ppm. This may mean that for 15 ms (e.g., one BLE connection event), the clock drift is around 1.5 us. A total of approximately 50 us clock drift (e.g., one Wi-Fi EDCA channel access overhead) could cause a collision of WLAN activity and second communication using a co-located radio (e.g., BLE). The 50 us clock drift may result from a continuous running time of 500 ms. Notably, a 500 ms running time may be approximately 5 beacon intervals. Hence one such clock update per 5 beacon intervals may be sufficient for intended operation, according to some embodiments. This may be considered low overhead.

In the case that, during one or more durations (D) of the second communication, the second communication ends prior to the end of the duration, the wireless device may determine early availability (e.g., for a next active time for the first communication) and may determine to indicate that availability to the AP. For example, as shown in FIG. 10, during a duration/target absence period 802d, the second communication may end prior to the conclusion of a target absence period, e.g., at 1002. Thus, communication according to the first RAT may start early, e.g., prior to the conclusion of the target absence period, e.g., at 1006.

In the case of repetitive communication, the updated characteristic(s) may be or include a remaining time for a current fixed period for the first communication. For example, as shown in FIG. 11, during respective periods for the first communication, the wireless device may determine an amount of time remaining (e.g., left over time). The amount of time may be determined based on the time that an indication (1102a, 1102b, 1102c) of the time remaining is to be transmitted. For example, remaining time 1104 may be the amount of time between the indication 1102a and the end of the fixed WLAN time.

It will be appreciated that other characteristics (e.g., period, duration, maximum duration, bandwidth characteristics, etc.) may be updated also, e.g., if they are changed.

The wireless device may indicate the one or more updated characteristic(s) to the AP (714), according to some embodiments. The AP may receive the indication.

In some embodiments, the updated characteristic(s) may be transmitted opportunistically, e.g., at a time that the wireless device is able to do so and potentially in conjunction with another message. For example, during a WLAN activity time, a wireless device may opportunistically transmit an update to the AP.

For example, adjusted clock information (e.g., new t0) may be transmitted using any of: a new type of action frame for clock synchronization, a new type of A-Control header that can be carried with uplink data (e.g., if any is to be transmitted), and/or a new variant of an acknowledgement frame (e.g., such as a multi-STA block acknowledgement) frame (e.g., when responding to DL data from the AP).

Similarly, in the case of periodic communication when the wireless device has determined early availability for an active time of the first communication, may transmit an indication to the AP, e.g., that the wireless device is available from the time of the indication until a next duration of communication for the second communication. The indication may be or include a trigger for DL communication (e.g., a PM frame with PM=0) or a new action frame. In some embodiments, the wireless device may transmit uplink data to the AP and such uplink data may be considered an indication of early availability. As shown in FIG. 10, the wireless device may transmit an early availability indication 1006, allowing first communication to start at that time.

Similarly, in the case of repetitive communication, the wireless device may indicate the remaining (e.g., left-over) available WLAN time during an ongoing fixed WLAN time. Such an indication may be transmitted using on or more of: a new type of Action frame (e.g., which may be aggregated with a trigger for DL communication, e.g., may indicate PM=0), a new type of A-Control header that can be carried with uplink data (e.g., if any is to be transmitted), and/or a new variant of an acknowledgement frame (e.g., such as a multi-STA block acknowledgement) frame (e.g., when responding to DL data from the AP). As shown in FIG. 11, a trigger for DL communication and a remaining time indication may be transmitted in the same frame (1102b) or separate frames (1102c). Such an indication may allow the AP to know how much time is available for first communication during the (e.g., remainder of the) fixed time.

It will be appreciated that 1102a-c are different examples of remaining time indications. These examples may be used in any combination and/or may occur in any order. For example, in some embodiments, all remaining time indications may be similar to any one of 1102a, b, or c or such indications may be selected as desired.

The AP may determine (e.g., updated) times to avoid transmitting DL communication to the wireless device and/or determine times for such transmissions (716), according to some embodiments. The AP may make this determination based on the initial characteristics (e.g., received in 706) and/or updated characteristics (e.g., received in 714).

In the case of periodic communication, if the updated characteristic(s) include an early availability indication, the AP may set a PM bit to 0 in response to the early availability indication. Accordingly, the AP may determine that the wireless device is available to receive from the time of the indication until the beginning of a next communication duration for the second communication. In the example of FIG. 10, the AP may receive the indication 1006 and, based on the indication, determine that the wireless device is available from 1006 to 1008. Similarly, the AP may anticipate that the wireless device may not be available for duration D beginning at 1008.

In the case of repetitive communication, if the updated characteristics include an indication of remaining time and/or a DL trigger, the AP may determine that the wireless device may be available for the remaining time. Thus, the AP may set a PM bit to 0 in response to the indication. For example, in FIG. 11, based on indication 1102a, the AP may set PM to 0 for remaining time 1104. Thus, during 1104, the AP may exchange data with the wireless device. Further, the AP may set PM bit to 1 at the end of the remaining time 1104, and thus may pause communication with the wireless device and wait for a next indication (e.g., 1102b) from the wireless device to resume communication.

In the event that the updated characteristics include updates to the initial characteristics (e.g., received in 706), the AP may update the time(s) as discussed with respect to 708. For example, in the case that the updated characteristics include a new start time (new t0), then the AP may shift a schedule of anticipated available times and target absence times based on the new start time. Similarly, if any bandwidth, duration, or other characteristics, the AP may incorporate the updated information in the determination.

The wireless device may perform first communication with the AP (718a) and second communication with the second device (718b), according to some embodiments. The wireless device may alternate between the first/second communication, e.g., according to TDM. The AP may avoid transmitting DL communication to the wireless device at any time that the wireless device may be unavailable (e.g., as determined in 716).

In some embodiments, if bandwidth characteristics are used, the second communication may be multiplexed (e.g., FDM) with the first communication, e.g., at times that the second communication is active.

The wireless device and/or second device may end the second communication (720), according to some embodiments. For example, the wireless device may end a BT, BLE, or narrowband communication session with the second device.

The wireless device may transmit an indication to the AP of the end of the second communication (722), according to some embodiments. The indication may be transmitted in advance of the ending (and may indicate a planned time of the ending), concurrently with the ending, or after the ending. For example, as shown in FIG. 8, the wireless device may transmit an action frame 806 comprising the indication.

After the end of the second communication, the wireless device may perform first communication with the AP (724), according to some embodiments. The first communication may be performed without restriction based on the co-existence of the second communication. In other words, the AP may set a PM bit to 0 for the wireless device, e.g., indicating that the wireless device is available to receive. For example, in the case of periodic communication, in response to an indication (e.g., 806, in the example of FIG. 8), the AP may cancel target absence periods (e.g., and leave PM=0 at these times). Similarly, in the case of repetitive communication, the AP may consider that the remaining time is unlimited (e.g., until a future indication is received from the wireless device).

### Contrast to U-APSD and TWT

In the following, the method of FIG. 7 is contrasted against unscheduled automatic power save deliver (U-APSD) and/or target wake time (TWT).

U-APSD co-existence may rely on U-APSD trigger, e.g., to trigger DL transmission. In the case of periodic communications, according to the method of FIG. 7, no DL trigger may be required (e.g., in contrast to U-APSD which does require a trigger), e.g., because the AP is aware of a target absence time. The U-APSD co-existence scheme may rely on an ADDTS request/response mechanism which involves per access category (AC) TSPEC/TCLASS processing first. A base ADDTS request (including a TSPEC element) may need to be granted before processing U-APSD co-existence element. The ADDTS and TSPEC/TCLASS signaling may be relatively heavy (e.g., may include large amounts of signaling overhead). In contrast, the methods of FIG. 7 may not rely on such heavy signaling, e.g., as no ADDTS and/or AC signaling is required. Thus, the requirement for AP when receiving characteristics (e.g., used to determine a target absence time, e.g., in 706/708, etc.) may be similar to the requirements of receiving a PM frame. For example, in FIG. 7, comparing to a PM frame, the frame of target absence period indication may include additional information about the communication pattern of the second communication (e.g., periodic duration of absence time). In some embodiments, the AP must honor such an indication from the wireless device in the method of FIG. 7 by stopping transmitting to the wireless device during periods when the device may not be available based on the communication pattern, e.g., it may not be a negotiation process. However, U-APSD is a negation (e.g., including the ADDTS request/response process). This negotiation may be avoided in the method of FIG. 7.

Individual TWT may be used to minimize contention and reduce the amount of time that a wireless device in power save mode may need to be awake. Thus, in theory it may be possible to schedule individual TWT with AP during a WLAN activity time. However, individual TWT may restrict the behavior of WLAN activity to a single service period (SP) of operation. In TWT, trigger based SPs may be used. The whole WLAN activity time (e.g., according to methods of FIG. 7) may be greater than one SP. Thus, the method of FIG. 7 avoids this limitation of individual TWT. Further, the method of FIG. 7 may reduce signaling relatively to hypothetically scheduling TWT during each active period, e.g., because periodic/repetitive characteristics may be provided to the AP.

### Additional Information and Examples

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In one set of embodiments, a wireless device may establish communication with an access point (AP) according to a first radio access technology (RAT) and may establish communication with a second device according to a second RAT different from the first RAT. The wireless device may determine that the communication with the second device according to the second RAT is periodic communication. In response to the determination that the communication with the second device according to the second RAT is periodic communication, the wireless device may determine at least one of: the starting time of next periodic communication; or a periodicity of the periodic communication; or a periodic communication duration of the periodic communication, wherein the communication with the second device according to the second RAT occurs during respective communication durations of respective periods of the periodic communication. The wireless device may transmit, to the AP, an indication of the at least one of: the starting time of next periodic communication; or the periodicity of the periodic communication; or the periodic communication duration of the periodic communication.

In some embodiments, the processor is further configured to cause the wireless device to: determine a start time of a first period of the periodic communication; and transmit, to the AP, an indication of the start time of the first period of the periodic communication.

In some embodiments, the processor is further configured to cause the wireless device to: determine that a first clock associated with the first RAT is drifting relative to a second clock associated with the second RAT; and in response to the determination that the first clock associated with the first RAT is drifting relative to the second clock associated with the second RAT: determine a start time of a second period of the periodic communication; and transmit, to the AP, an indication of the start time of the second period of the periodic communication.

In some embodiments, the indication of the start time of the second period of the periodic communication comprises one of: a clock synchronization action frame; an A-control header transmitted with uplink data; or a field in a block acknowledgement frame.

In some embodiments, the processor is further configured to cause the wireless device to: determine that, for a current period of the periodic communication, the communication with the second device according to the second RAT ends prior to a completion of a current periodic communication duration; and transmit, to the AP, an indication that the communication with the second device according to the second RAT ends prior to the completion of the current periodic communication duration.

In some embodiments, the indication that the communication with the second device according to the second RAT ends prior to the completion of the current periodic communication duration comprises one of: an uplink data communication; or an action frame.

In some embodiments, the processor is further configured to cause the wireless device to: determine, for a first period of the periodic communication, a first center frequency of the periodic communication for the first period; and transmit, to the AP, an indication of the first center frequency of the periodic communication for the first period.

In some embodiments, the processor is further configured to cause the wireless device to: determine a frequency hopping pattern of the periodic communication; and transmit, to the AP, an indication of the frequency hopping pattern of the periodic communication.

In some embodiments, the processor is further configured to cause the wireless device to: determine a bandwidth of the periodic communication; and transmit, to the AP, an indication of the bandwidth of the periodic communication.

In some embodiments, the processor is further configured to cause the wireless device to: avoid communication according to the first RAT during respective periodic communication durations of the periodic communication.

In some embodiments, the avoided communication according to the first RAT is communication with the AP.

In some embodiments, the avoided communication according to the first RAT is communication with a device other than the AP.

In some embodiments, the processor is further configured to cause the wireless device to: determine that the periodic communication is ending; and in response to the determination that the periodic communication is ending, transmit, to the AP, an indication that periodic communication is ending.

In one set of embodiments, a wireless device may establish first communication with an access point (AP) according to a first radio access technology (RAT) and establish second communication with a second device according to a second RAT different from the first RAT. The wireless device may determine that the first communication and the second communication are scheduled according to a first coexistence scheme in which: the first communication and the second communication are scheduled according to time division multiplexing; the first communication occurs in fixed duration time windows; and the second communication occurs in variable duration time windows. In response to the determination that the first communication and the second communication are scheduled according to the first coexistence scheme: determine, for a first fixed duration time window, an amount of time remaining in the first fixed duration time window; and transmit, to the AP, an indication of the amount of time remaining in the first fixed duration time window.

In some embodiments, the processor is further configured to cause the wireless device to: transmit, to the AP, an indication of a duration of the fixed duration time windows. For example, the time windows of the fixed duration time windows may have the same duration. The wireless device may indicate that duration.

In some embodiments, the indication of the amount of time remaining in the first fixed duration time window comprises an action frame including a trigger for downlink communication.

In some embodiments, the indication of the amount of time remaining in the first fixed duration time window comprises an A-control header transmitted with uplink data.

In some embodiments, the indication of the amount of time remaining in the first fixed duration time window comprises a block acknowledgement with a field indicating the amount of time remaining in the first fixed duration time window.

In one set of embodiments, a method, at an access point (AP) may comprise: establishing communication with a wireless device according to a first radio access technology (RAT). The method may include receiving, from the wireless device, a first indication that the wireless device is performing periodic communication with a second device, wherein the first indication comprises at least one of: the starting time of next periodic communication; or a periodicity of the periodic communication; or a periodic communication duration of the periodic communication, wherein the communication with the second device according to the second RAT occurs during respective communication durations of respective periods of the periodic communication. In response to the first indication, the method may include determining to avoid scheduling communication with the wireless device during at least a first period of the periodic communication.

In some embodiments, the method further comprises receiving a second indication that, for a first period of the periodic communication, the periodic communication finishes prior to an end of a second periodic communication duration of the periodic communication; and in response to the second indication, transmit data to the wireless device prior to the end of the second periodic communication duration of the periodic communication.

In some embodiments, the method further comprises: in response to the second indication, unsetting a power management bit associated with the wireless device.

In some embodiments, the method further comprises: receiving, from the wireless device, a third indication updating a start time of a third period of the periodic communication; and in response to the third indication, updating a schedule for communication with the wireless device during the third period of the periodic communication.

In some embodiments, the method further comprises: receiving, from the wireless device, a fourth indication indicating an end time of the periodic communication; and in response to the fourth indication, resuming performing communication with the wireless device without avoiding scheduling communication with the wireless device based on the periodic communication.

It will be appreciated that the various indications mentioned in the preceding paragraphs (e.g., first through fourth) are labeled for the sake of clarity, and there is no implication that these indications all occur in the order in which they are recited. These indications may occur in a different order. Moreover, any of these indications may be omitted in various embodiments. For example, the first indication may be followed by the fourth indication and the second and third indications may be omitted. Numerous similar examples are also possible.

In one set of embodiments, a method may comprise, at a wireless device: establish communication with an access point (AP) according to a first radio access technology (RAT). Establish communication with a second device according to a second RAT different from the first RAT. Determine that the communication with the second device is periodic communication. In response to the determination that the communication with the second device is periodic communication, determine at least one of: a periodicity of the periodic communication; or a periodic communication duration of the periodic communication, wherein the communication with the second device occurs during respective communication durations of respective periods of the periodic communication. Transmit, to the AP, an indication of the at least one of: the periodicity of the periodic communication; or the periodic communication duration of the periodic communication.

In one set of embodiments, a method may comprise, at a wireless device: establish communication with an access point (AP) according to a first radio access technology (RAT). Establish communication with a second device according to a second RAT different from the first RAT. Determine that the communication with the second device is periodic communication. In response to the determination that the communication with the second device is periodic communication, determine at least one of: a periodicity of the periodic communication; or a periodic communication duration of the periodic communication, wherein the communication with the second device occurs during respective communication durations of respective periods of the periodic communication. Transmit, to the AP, an indication of the at least one of: the periodicity of the periodic communication; or the periodic communication duration of the periodic communication.

In one set of embodiments, a method may comprise, at an access point (AP): establishing communication with a wireless device according to a first radio access technology (RAT). Receiving, from the wireless device, a first indication that the wireless device is performing periodic communication with a second device according to a second RAT, wherein the first indication comprises at least one of: a periodicity of the periodic communication; or a periodic communication duration of the periodic communication, wherein the communication with the second device occurs during respective communication durations of respective periods of the periodic communication. In response to the first indication, determining to avoid scheduling communication with the wireless device during at least a first periodic communication duration.

Any of the methods described herein for operating a wireless device may be the basis of a corresponding method for operating an AP and vice versa, e.g., by interpreting each message/signal X received by the wireless device in the DL as message/signal X transmitted by the AP, and each message/signal Y transmitted in the UL by the wireless device as a message/signal Y received by the AP. Moreover, a method described with respect to an AP may be interpreted as a method for a wireless device in a similar manner.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a wireless device may be configured to include a processor (and/or a set of processors) and a memory medium, where the memory medium stores program instructions, where the processor is configured to read and execute the program instructions from the memory medium, where the program instructions are executable to cause the wireless device to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus, comprising:
a processor configured to cause a wireless device to:
establish communication with an access point (AP) according to a first radio access technology (RAT);
establish communication with a second device according to a second RAT different from the first RAT;
in response to determining that the communication with the second device comprises periodic communication, determine at least one of:
a periodicity of the periodic communication; or
a duration of the periodic communication; and
transmit, to the AP, an indication of the at least one of:
the periodicity of the periodic communication; or
the duration of the periodic communication.

2. The apparatus of claim 1, wherein the processor is further configured to cause the wireless device to:
determine a start time of a first period of the periodic communication; and
transmit, to the AP, an indication of the start time.

3. The apparatus of claim 2, wherein the processor is further configured to cause the wireless device to:
determine that a first clock associated with the first RAT is drifting relative to a second clock associated with the second RAT;
determine a start time of a subsequent period of the periodic communication; and
transmit, to the AP, an indication of the start time of the subsequent period.

4. The apparatus of claim 3, wherein the indication of the start time of the subsequent period comprises one of:
a clock synchronization action frame;
an A-control header transmitted with uplink data; or
a field in a block acknowledgement frame.

5. The apparatus of claim 1, wherein the processor is further configured to cause the wireless device to:
determine that, for a current period of the periodic communication, the communication with the second device ends prior to an end of the current period; and
transmit, to the AP, an indication that the communication with the second device ends prior to the end of the current period.

6. The apparatus of claim 5, wherein the indication that the communication with the second device ends prior to the end of the current period comprises one of:
an uplink data communication; or
an action frame.

7. The apparatus of claim 1, wherein the processor is further configured to cause the wireless device to:
transmit, to the AP, an indication of a first center frequency associated with the periodic communication.

8. The apparatus of claim 7, wherein the processor is further configured to cause the wireless device to:
transmit, to the AP, an indication of a frequency hopping pattern associated with the periodic communication.

9. The apparatus of claim 7, wherein the processor is further configured to cause the wireless device to:
transmit, to the AP, an indication of a bandwidth associated with the periodic communication.

10. The apparatus of claim 1, wherein the processor is further configured to cause the wireless device to:
avoid communication according to the first RAT during a periodic communication duration of the periodic communication.

11. The apparatus of claim 1, wherein the processor is further configured to cause the wireless device to:
transmit, to the AP, an indication that the periodic communication is ending.

12. An apparatus, comprising:
a processor configured to cause a wireless device to:
establish first communication with an access point (AP) according to a first radio access technology (RAT);
establish second communication with a second device according to a second RAT different from the first RAT;
determine that the first communication and the second communication are scheduled according to a first coexistence scheme in which:
the first communication and the second communication are scheduled according to time division multiplexing;
the first communication occurs in fixed duration time windows; and
the second communication occurs in variable duration time windows; and
in response to determining that the first communication and the second communication are scheduled according to the first coexistence scheme, transmit, to the AP, an indication of an amount of time remaining in a first fixed duration time window.

13. The apparatus of claim 12, wherein the processor is further configured to cause the wireless device to:
transmit, to the AP, an indication of a duration of the fixed duration time windows.

14. The apparatus of claim 13, wherein an action frame including a trigger for downlink communication comprises the indication of the amount of time remaining in the first fixed duration time window.

15. The apparatus of claim 12, wherein an A-control header transmitted with uplink data comprises the indication of the amount of time remaining in the first fixed duration time window.

16. The apparatus of claim 12, a block acknowledgement comprises a field indicating the amount of time remaining in the first fixed duration time window.

17. A method, comprising:
at an access point (AP):
establishing communication with a wireless device according to a first radio access technology (RAT);
receiving, from the wireless device, a first indication that the wireless device is performing periodic communication with a second device according to a second RAT, wherein the first indication comprises at least one of:
a periodicity of the periodic communication; or
a periodic communication duration of the periodic communication; and
in response to the first indication, avoiding scheduling communication with the wireless device during an instance of the periodic communication.

18. The method of claim 17, further comprising:
receiving a second indication that, for a first periodic communication duration, the periodic communication finishes prior to an end of the first periodic communication duration; and
transmit data to the wireless device prior to the end of the first periodic communication duration.

19. The method of claim 18, further comprising:
receiving, from the wireless device, a third indication indicating an end time of the periodic communication; and
resuming communication with the wireless device without avoiding scheduling communication with the wireless device based on the periodic communication.

20. The method of claim 17, further comprising:
receiving, from the wireless device, a fourth indication updating a start time of a subsequent period of the periodic communication; and
updating a schedule for communication with the wireless device during the subsequent period.
